(19) United States
(12) Patent Application Publication
(10) Pub. No.: US 2016/0031010 A1
(43) Pub. Date: Feb. 4, 2016

(54) BUILD PLATFORMS FOR ADDITIVE MANUFACTURING

(71) Applicant: United Technologies Corporation, Hartford, CT (US)

(72) Inventors: Christopher F. O'Neill, Hebron, CT (US); Jesse R. Boyer, Middletown, CT (US); Robert P. Delisle, Colchester, CT (US)

(21) Appl. No.: 14/772,661

(22) PCT Filed: Mar. 3, 2014
(86) PCT No.: PCT/US2014/019872

§ 371 Date: Sep. 3, 2015

Related U.S. Application Data
(60) Provisional application No. 61/772,725, filed on Mar. 5, 2013.

(51) Int. Cl. B22F 3/105; B22F 3/24

(52) U.S. Cl. CPC B22F 3/1055; B22F 3/24; B22F 2003/1058; B22F 2003/247; B33Y 10/00

(57) ABSTRACT

An additive manufacturing apparatus is disclosed which includes a movable platform. The movable platform has a plurality of fasteners and an upper surface, and at least one indexing feature. An upper surface of a movable platform is coupled with an indexing device such that movement of either one corresponds to movement of the other. The indexing device is capable of receiving a compatible indexing device from a manufacturing

### BACKGROUND

This invention relates generally to the field of additive manufacturing. In particular, the present invention relates to an article that facilitates additive manufacturing and subsequent subtractive manufacturing of a part.

Additive manufacturing refers to a category of manufacturing methods characterized by the fact that the finished part is created by layerwise construction of a plurality of thin sheets of material. Additive manufacturing may involve applying liquid or powder material to a workstage, then doing some combination of sintering, curing, melting, and/or cutting to create a layer. The process is repeated up to several thousand times to construct the desired finished component or article.

Various types of additive manufacturing are known. For example, stereolithography (additively manufacturing objects from layers of a cured photosensitive liquid), Electron Beam Melting (using a pulverant material as feedstock and selectively melting the pulverant material using an electron beam), Laser Additive Manufacturing (using a pulverant material as a feedstock and selectively melting the pulverant material using a laser), and Laser Object Manufacturing (applying thin, solid sheets of material over a workstage and using a laser to cut away unwanted portions) are known.

Depending on the application, the surface of an additively manufactured component may be unacceptably rough. Thus, many additively manufactured components are subjected to subtractive manufacturing processes such as grinding, milling, or sanding. These subtractive manufacturing processes remove surface roughness and ensure that the finished part has the desired dimensions. These subtractive manufacturing processes often require indexing of the additively manufactured part to determine its pre-subtractive manufacturing dimensions, followed by machining by a skilled machinist The indexing of the part is often accomplished by “touch” indexing, or using a probe to measure the pre-subtractive manufacturing dimensions of the additively manufactured part. Touch indexing is a time-consuming process, and given the level of skill required by the machinist, can also add expense.

### SUMMARY

A manufacturing system includes an additive manufacturing apparatus and a movable platform. The movable platform includes a plurality of fasteners, an upper surface, and an indexing system. The movable platform is capable of connecting with the additive manufacturing apparatus.

A method of manufacturing includes additively manufacturing an object on a support structure with an indexing feature. The object is built onto the support structure. The movable platform is transferred to a subtractive manufacturing apparatus, where the object is subtractively manufactured using the indexing feature to determine the location where material is removed.

### BRIEF DESCRIPTION OF THE DRAWINGS

FIG. 1 is a flowchart of a method for using the invention.

FIG. 2 is a perspective view of a movable platform showing an indexing system.

FIG. 3 is a perspective view of an additive manufacturing device incorporating the invention.

### DETAILED DESCRIPTION

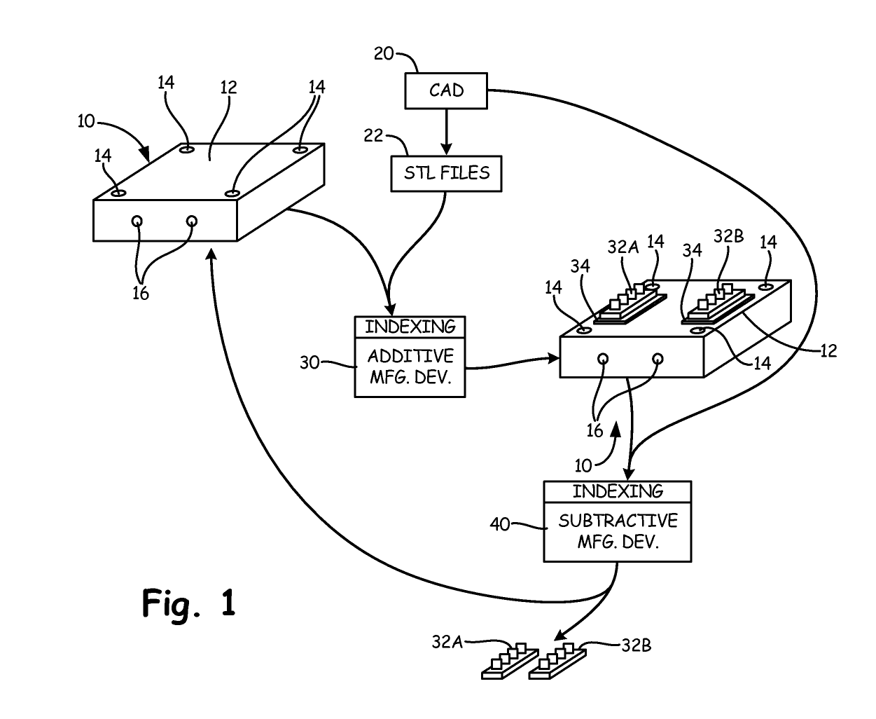

FIG. 1 shows a flowchart of a process for creating additively manufactured components without the need for re-indexing the additively manufactured part prior to subtractive manufacturing. FIG. 1 shows movable platform 10, which includes upper surface 12, fastener holes 14, and indexing system 16. FIG. 1 also includes CAD 20 and STL files 22, as well as additive manufacturing device 30 and subtractive manufacturing device 40. FIG. 1 also shows additively manufactured components 32A and 32B.

Movable platform 10 is any object which is capable of being mounted to additive manufacturing device 30 and subtractive manufacturing device 40, and upon which additively manufactured components may be built. For example, movable platform 10 may be a metal platform. Upper surface 12 is a surface over which additive manufacturing may be performed. Typically, upper surface 12 is flat. Fastener holes 14 in movable platform 10 are holes through which fasteners (not shown) may pass to connect movable platform 10 to other objects, such as additive manufacturing device 30 or subtractive manufacturing device 40. For example, fastener holes 14 may be threaded or unthreaded holes through which screws or bolts may pass. In alternative embodiments, fastener holes 14 may be unnecessary. For example, movable platform 10 could be fastened to additive manufacturing device 30 and/or subtractive manufacturing device 40 magnetically, or movable platform 10 could be clamped to additive manufacturing device 30 and/or subtractive manufacturing device 40.

Indexing system 16 is a pair of bushings configured to receive a pair of pins. In alternative embodiments, indexing system 16 could be any device which cooperates with a complimentary device on additive manufacturing device 30 and subtractive manufacturing device 40.

Three-dimensional image file 20 and two-dimensional image file 22 are files used in the generation of parts. In the embodiment shown in FIG. 1, three-dimensional image file 20 is a Computer Aided Design (CAD) file, and two-dimensional image file 22 is a Stereolithography (STL) file. STL files typically contain instructions for an additive manufacturing device to create one layer of the object being manufactured. As such, a plurality of two-dimensional image files 22 may be generated from a three-dimensional image file 20.

Additively manufactured components 32A and 32B, as well as sacrificial layers 34, are parts generated by additive manufacturing. 32A and 32B are vane sections. In alternative embodiments, additively manufactured components 32A and 32B could be any additively manufactured component. Sacrificial layers 34 are additively manufactured parts that are grown underneath additively manufactured components 32A and 32B by additive manufacturing, but are not intended to be used as a finished part. For example, sacrificial layer 34 could be a solid layer designed to be cut off from a finished additively manufactured part, or sacrificial layer 34 could be a honeycomb-type sacrificial layer designed to be cut off from a finished additively manufactured part. Additively manufactured components 32A and 32B are also shown after undergoing subtractive manufacturing in subtractive manufacturing device 40.

The cycle shown in FIG. 1 involves indexing movable platform 10 in additive manufacturing device 30 using indexing system 16 and a cooperating indexing feature (not shown) in additive manufacturing device 30. Three-dimensional image file 20 is used to generate two-dimensional image files 22, which are transmitted to additive manufacturing device 30. Additive manufacturing device 30 indexes movable platform 10, and generates sacrificial layers 34 and additively manufactured parts 32A and 32B on surface 12 of movable platform 10 in accordance with the instructions in two-dimentional image file 22. Movable platform 10 is then removed from additive manufacturing device 30 and transferred to subtractive manufacturing device 40. Movable platform 10 is indexed in subtractive manufacturing device 40 using indexing system 16 and a cooperating indexing feature (not shown) in subtractive manufacturing device 40. Three-dimensional image file 20 is transmitted to subtractive manufacturing device 40, which performs desired subtractive manufacturing on additively manufactured parts 32A and 32B such as milling, grinding, and/or cutting. Subtractive manufacturing device 40 also separates movable platform 10 from sacrificial layers 34, and separates sacrificial layers 34 from additively manufactured parts 32A and 32B. When subtractive manufacturing concludes, movable platform is ready for reuse and finished parts 32A and 32B are complete.

The location of additively manufactured parts 32A and 32B in relation to movable platform 10 can be maintained while the part is processed through one or more subtractive manufacturing devices 40. This negates the need to locate and index the part for each operation and provides for more accurate machining of the part.

Additionally, the single piece flow achieved by the cycle shown in FIG. 1 allows for multiple platforms to be used within additive manufacturing device 30 and/or subtractive manufacturing device 40 simultaneously. By using multiple platforms, more additively manufactured parts, such as 32A and 32B, can be generated and subsequently accessed by subtractive manufacturing devices 40, increasing productivity.

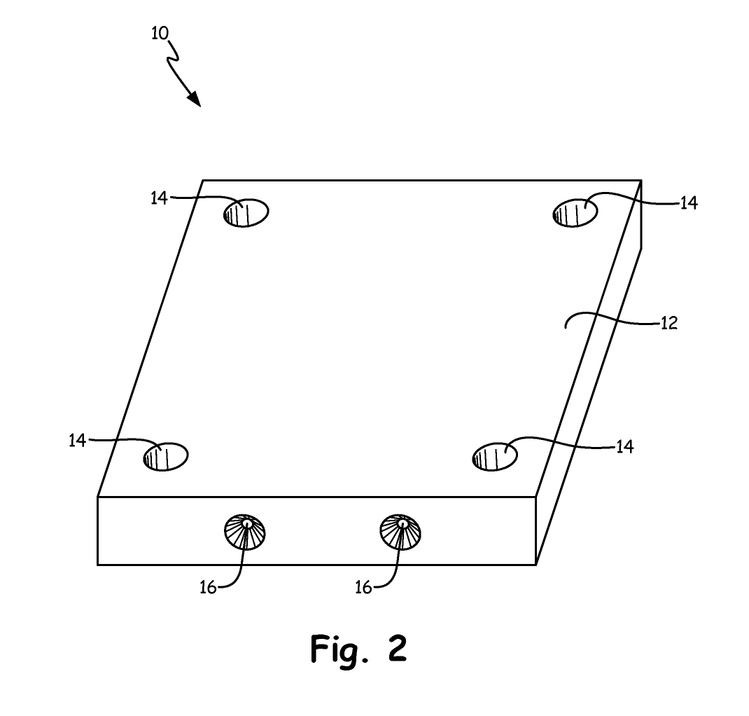

FIG. 2 is a perspective view of movable platform 10. As described with respect to FIG. 1, movable platform 10 in FIG. 2 includes upper surface 12, fastener holes 14, and indexing system 16. Indexing system 16 includes a pair of bushings configured to compliment pairs of pins in certain devices, such as additive manufacturing device 30 (FIG. 1) and/or subtractive manufacturing device 40 (FIG. 1). Indexing system 16 may be used along with compatible indexing instruments in an additive or subtractive manufacturing device in order to infer the position of upper surface 12 and any features built thereon. When, as shown in FIG. 2, bushings are used to attach movable platform 10 to compatible devices having compatible pins, insertion of the pins into the platform allows the compatible device to infer the position of contours along surface 12.

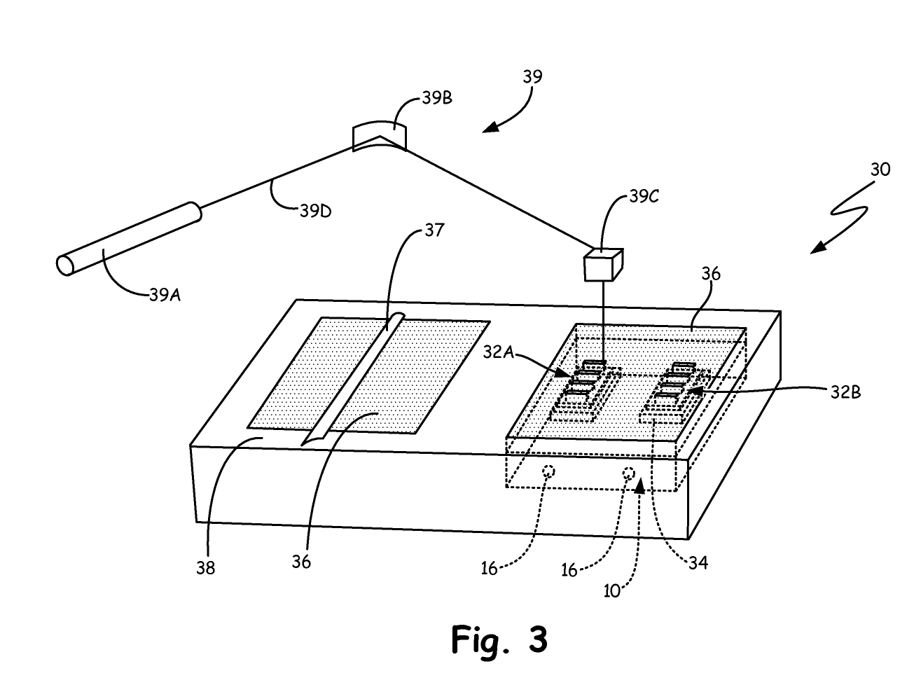

FIG. 3 is a perspective view of additive manufacturing device 30 during additive manufacturing on movable platform 10. Additive manufacturing device 30 includes pulverant material 36, spreader 37, housing 38, and optical system 39. Pulverant material 36 is any material suitable for additive manufacturing, such as powdered metal or polymer. Spreader 37 is used to transfer thin layers of pulverant material 36 to a region where parts are being additively manufactured. For example, spreader 37 may be a knife blade spreader or a roller. Housing 38 is used to contain pulverant material 36 and includes an indexing feature that cooperates with indexing system 16 on movable platform 10. Optical system 39 includes radiation source 39A, minor 39B, movable optical head 39C, and radiation beam 39D. As shown in FIG. 3, radiation source 39A is a laser. However, in alternative embodiments, radiation source 39A could be any source of radiation which serves to sinter or melt pulverant material 36. For example, radiation source 39A may, in other embodiments, be an electron beam.

In the embodiment shown in FIG. 3, indexing system 16 is connected to housing 38 of additive manufacturing device 30. Accordingly, additive manufacturing device 30 can additively manufacture additively manufactured parts 32A and 32B based on their position relative to indexing system 16. Likewise, when movable platform 10 is transferred from additive manufacturing device 30 to subtractive manufacturing device 40, subtractive manufacturing device 40 can machine sacrificial layers 34 and additively manufactured parts 32A and 32B based on their relative position to indexing system 16. The location of additively manufactured parts 32A and 32B in relation to movable platform 10 can be maintained while the part is processed through one or more subtractive manufacturing devices 40. This negates the need to locate and index the part for each operation and provides for more accurate machining of the part.

### POSSIBLE EMBODIMENTS

The following are non-exclusive descriptions of possible embodiments of the present invention.

A manufacturing system includes an additive manufacturing apparatus including a solidifiable material delivery system capable of delivering solidifiable material to a stage, and a movable platform capable of connecting to the additive manufacturing apparatus. The stage includes a plurality of fasteners, an upper surface, and at least one indexing system.

The manufacturing system of the preceding paragraph can optionally include, additionally and/or alternatively, any one or more of the following features, configurations and/or additional components:

The manufacturing system may also include a subtractive manufacturing apparatus capable of connecting to the movable platform. The movable platform may be capable of connecting to the additive manufacturing apparatus and the subtractive manufacturing apparatus via the indexing system. The indexing system may include a pair of bushings arranged on the movable platform, which may allow the additive manufacturing apparatus and the subtractive manufacturing apparatus to connect to the indexing system of the movable platform via pins that are compatible with the bushings. The manufacturing system may further include one or more additional movable platforms.

According to another embodiment, a method of manufacturing an object includes the steps of attaching a movable platform to an additive manufacturing apparatus, indexing the relative position of the movable platform to the additive manufacturing apparatus, additively manufacturing a support structure on the movable platform with the additive manufacturing apparatus, additively manufacturing an object on the support structure with the additive manufacturing apparatus, transferring the movable platform, the support structure, and the object to a subtractive manufacturing apparatus, indexing the relative position of the movable platform to the subtractive manufacturing apparatus, subtractively manufacturing the object, and separating the object from the movable platform.

The method of the preceding paragraph can optionally include, additionally and/or alternatively, any one or more of the following features, configurations, steps, and/or additional components:

The additive manufacturing apparatus may be one of the group consisting of a direct metal laser sintering apparatus, a selective laser sintering apparatus, a laser engineered net shaping apparatus, or an electron beam melting apparatus. The support structure may be a honeycomb mesh.

Separating the object from the movable platform may include cutting the object from the support structure and cutting the support structure from the movable platform.

Indexing the relative position of the movable platform to the additive manufacturing apparatus may include indexing a surface of the movable platform on which the object will be manufactured. Indexing the relative position of the movable platform to the additive manufacturing apparatus may include aligning a pin located on the additive manufacturing apparatus within a bushing located on the movable platform. Indexing the relative position of the movable platform to the additive manufacturing apparatus may include aligning a pin located on the movable platform within a bushing located on the additive manufacturing apparatus. Indexing the relative position of the movable platform to the subtractive manufacturing apparatus may include indexing the object. Indexing the relative position of the movable platform to the subtractive manufacturing apparatus may include aligning a pin located on the subtractive manufacturing apparatus within a bushing located on the movable platform. The method may also include aligning a second pin located on the subtractive manufacturing apparatus within a second bushing located on the movable platform. Indexing before subtractively manufacturing may be performed without touch-indexing the object.

According to another embodiment, a movable platform includes a working surface, fasteners mechanically coupled with the surface, and an indexing device coupled with the fasteners and the working surface, wherein movement of the working surface necessarily corresponds to movement of the indexing device and the indexing device is capable of receiving compatible indexing features from a manufacturing device.

The movable platform of the preceding paragraph can optionally include, additionally and/or alternatively, any one or more of the following features, configurations and/or additional components:

The indexing device may include a pair of bushings configured to receive pins from an additive or subtractive manufacturing device.

According to a further embodiment, a manufacturing system allows for multiple platforms to be used simultaneously. The system includes an additive manufacturing device configured to engage with an indexable type movable platform. The system further includes a subtractive manufacturing device configured to engage with the indexable type movable platform. The subtractive manufacturing device is configured be operated concurrently with the additive manufacturing device.

The manufacturing system of the preceding paragraph can optionally include, additionally and/or alternatively, any one or more of the following features, configurations and/or additional components:

The system may also include a plurality of the indexable type movable platforms.

Although the present invention has been described with reference to preferred embodiments, workers skilled in the art will recognize that changes may be made in form and detail without departing from the spirit and scope of the invention.

1. A method of manufacturing an object, the method comprising:
attaching a movable platform to an additive manufacturing apparatus;
indexing the relative position of the movable platform to the additive manufacturing apparatus;
additively manufacturing a support structure on the movable platform with the additive manufacturing apparatus;
additively manufacturing an object on the support structure with the additive manufacturing apparatus;
transferring the movable platform, the support structure, and the object to a subtractive manufacturing apparatus;
indexing the relative position of the movable platform to the subtractive manufacturing apparatus;
subtractively manufacturing the object; and
separating the object from the movable platform.

2. The method of claim 1 wherein the additive manufacturing apparatus is one of the group consisting of:
a direct metal laser sintering apparatus;
a selective laser sintering apparatus;
a laser engineered net shaping apparatus; and
an electron beam melting apparatus.

3. The method of claim 1, wherein the support structure is a honeycomb mesh.

4. The method of claim 1, wherein separating the object from the movable platform includes cutting the object from the support structure and cutting the support structure from the movable platform.

5. The method of claim 1, wherein indexing the relative position of the movable platform to the additive manufacturing apparatus includes indexing a surface of the movable platform on which the object will be manufactured.

6. The method of claim 5, wherein indexing the relative position of the movable platform to the additive manufacturing apparatus includes aligning a pin located on the additive manufacturing apparatus within a bushing located on the movable platform.

7. The method of claim 5, wherein indexing the relative position of the movable platform to the additive manufacturing apparatus includes aligning a pin located on the movable platform within a bushing located on the additive manufacturing apparatus.

8. The method of claim 1, wherein indexing the relative position of the movable platform to the subtractive manufacturing apparatus includes indexing the object.

9. The method of claim 8, and further comprising aligning a second pin located on the subtractive manufacturing apparatus within a second bushing located on the movable platform.

10. The method of claim 1, wherein indexing before subtractively manufacturing is performed without touch-indexing the object.

11. A movable platform, comprising:
a working surface;
a plurality of fasteners mechanically coupled with the surface; and
an indexing device coupled with the fasteners and the working surface, wherein
movement of the working surface necessarily corresponds to movement of the indexing device; and
the indexing device is capable of receiving compatible indexing features from a manufacturing device.

12. The movable platform of claim 11, wherein the indexing device includes a pair of bushings configured to receive pins from an additive or subtractive manufacturing device.

13. The movable platform of claim 11, wherein:
the movable platform is configured to engage with an additive manufacturing apparatus, the additive manufacturing apparatus comprising a solidifiable material delivery system capable of delivering solidifiable material to a stage.

14. The movable platform of claim 13, wherein the movable platform is further configured to engage with a subtractive manufacturing apparatus.

15. The movable platform of claim 14, wherein the movable platform is configured to connect to the additive manufacturing apparatus and the subtractive manufacturing apparatus via the indexing system.

16. The movable platform of claim 15, wherein the indexing system includes a pair of bushings arranged on the movable platform.

17. The movable platform of claim 16, wherein the additive manufacturing apparatus and the subtractive manufacturing apparatus connect to the indexing system of the movable platform via pins that are compatible with the bushings.

18. A manufacturing system that allows for multiple platforms to be used simultaneously, the system comprising:
an additive manufacturing device configured to engage with an indexable type movable platform; and
a subtractive manufacturing device configured to engage with the indexable type movable platform, wherein the subtractive manufacturing device is further configured to be operated concurrently with the additive manufacturing device.

19. The system of claim 18, and further comprising a plurality of the indexable type movable platforms.
